(19) United States
(12) Patent Application Publication
(10) Pub. No.: US 2024/0374356 A1
(43) Pub. Date: Nov. 14, 2024

(54) Dental Implant Assembly

(71) Applicant: CeramTec GmbH, Plochingen (DE)

(72) Inventors: Mateusz Maria Juszczyk, Velden (DE); Andreas Rempp, Plochingen (DE)

(21) Appl. No.: 18/688,714

(22) PCT Filed: Aug. 30, 2022
(86) PCT No.: PCT/EP2022/074075

§ 371 Date: Mar. 1, 2024

(30) Foreign Application Priority Data
Sep. 3, 2021 (EP) 21194850.0
Oct. 5, 2021 (EP) 21200917.9

(51) Int. Cl. A61C 8/00

(52) U.S. Cl. CPC A61C 8/0066; A61C 8/0012; A61C 8/0068

(57) ABSTRACT

Provided is a dental implant assembly for insertion into the jawbone of a patient. The dental implant assembly is used to hold a dental prosthesis and includes a main body which connects the dental implant to the alveolar bone, an abutment and a connecting element. The main body and the abutment each have a coupling region. Together, these coupling regions form an interface. One of the coupling regions is concave and the other convex, and portions of the coupling regions are congruently shaped. The abutment and the main body are connected by means of a connecting element.

### CROSS-REFERENCE TO RELATED APPLICATIONS

This application is the United States national phase of International Patent Application No. PCT/EP2022/074075, filed Aug. 30, 2022, and claims priority to European Patent Application No. 21194850.0 filed Sep. 3, 2021 and European Patent Application No. 21200917.9 filed Oct. 5, 2021, the disclosures of which are hereby incorporated by reference in their entireties.

### BACKGROUND OF THE INVENTION

### Field of the Invention

The present disclosure relates to the field of dentistry and describes a dental implant which is inserted into the jawbone of a patient. The dental implant according to the solution serves to receive a crown, a dental prosthesis. The dental implant comprises a main body which connects the dental implant to the alveolar bone (i.e., the jawbone), an abutment and a connecting element. The abutment serves as a two-sided adapter which connects the dental prosthesis, the crown, to the implant. The abutment is fastened to the main body by means of the connecting element.

### Description of Related Art

One-part or two-part dental implants are known from the prior art. These extend along a first longitudinal axis between an apical and a coronal end, and the apical, endosseous part of the dental implant, the main body is intended to be embedded in the patient's jaw bone.

Dental implantology comprises the restoration of one or more teeth in the mouth of a patient with the aid of artificial components. These artificial components usually consist of a dental implant and a prosthetic dental crown fixedly connected to the dental implant. The dental implant can be designed as a one-piece element having an integrated connecting piece to the dental crown. In recent years, two-part dental implant systems have become established. A two-part dental implant generally consists of a main body anchored in the bone, and an abutment which acts as a connecting piece between the artificial dental crown and the main body of the dental implant. The main body is generally implanted by lifting a soft tissue flap and drilling the alveolar bone in order to prepare the dental implant bed. The main body is then inserted, a cap is attached to facilitate the healing process of the wound, and the wound is then sealed appropriately. After the healing process, the cap is removed and the abutment is screwed to the main body and/or cemented with a suitable fastening means. The prosthetic tooth, the artificial dental crown, can then be attached.

Dental implants are known which are completely embedded in the bone and finish flush with the bone level (juxta-osseous placement) or even somewhat below the bone level. These dental implants are referred to as bone level implants. A two-part surgical method is generally required for these implants. An implant whose shoulder projects a few millimeters above the bone level and thus contributes to the formation of the surrounding tissue is referred to as a tissue level implant.

The tissue level implant has an extended apical part, a collar that is in contact with the gingival (soft) tissue. These tissue level implants enable the dental implant to be inserted in a single surgical intervention and are therefore usually used for posterior implant locations.

In most dental implants, the surfaces of the main body and the abutment, which meet in the implanted state, are coordinated with one another so that they fit together so as to interlock and cannot be rotated against one another, such a plug and socket. In order to ensure a firm seat of the dental crown, an exactly positioned, non-rotating connection between the two parts has to be ensured. The abutment often has a recess, a countersunk hole, along the longitudinal axis of the abutment. This recess serves to receive a connecting means.

In general, titanium alloys are used for the production of dental implants, since these metals can easily be machined with the necessary high precision required for the very small dimensions of the dental implants. In addition, titanium alloys offer good mechanical stability and tightness of the compound due to their plastic flexibility, since they are forgiving of possible local stress concentrations.

However, the use of titanium alloys as the material for dental implants also entails disadvantages. On the one hand, the aesthetic aspect of the gray color, which may be visible at the gum edge. On the other hand, the release of metal ions and, as a result, allergic reactions of the patient, is increasingly becoming a problem in dental implantology. In recent times, these disadvantages and the current advances in ceramic materials have led to a further development of ceramic dental implant.

A plurality of two-part ceramic implants consisting of a main body and an abutment have been proposed. Some of these, as described in DE 21 2013 000248 U1, use a conical connection and a screw between the main body and the abutment, but in combination with a polymer cement at the interface. Direct ceramic-on-ceramic contact between the matching parts is thereby prevented. In contrast, WO 2018/046148 A1 proposes a ceramic-ceramic connection in combination with a plastics screw.

There are concerns in the prior art relating to two-part dental implants in which a ceramic main body is in contact with a ceramic abutment. Under load, for example during chewing, interfaces between the main body and the abutment can change, for example open or a gap can form. These changes may possibly lead to an increase in the point load beyond the acceptable load level, and thus may cause microcracks and/or failure of the dental implant.

The interface between the main body and the abutment still represents a mechanical challenge for a ceramic-on-ceramic solution. Some of these are: restrictions on the dimensions for the inclusion of necessary features such as thread, locking or rotation prevention, lower mechanical stability.

### SUMMARY OF THE INVENTION

In view of the prior art, the object underlying the proposed solution was to provide an improved two-part dental implant that comprises a secure, positionally accurate interface and is simple to use.

The object is achieved by a dental implant with features as described herein and by a dental kit with features as described herein. Embodiments can be freely combined with one another.

The dental implant according to the solution comprises a main body and an abutment with an interface matching the main body, and a connecting means which holds the main body and abutment in a positive-locking connection with one another. The main body forms the artificial tooth root. It is implanted in the alveolar bone. The main body comprises a shank portion located at the apical end of the main body, i.e., the end which is inserted into the alveolar bone, a coupling portion at the coronal end of the main body and a recess which extends from the coupling portion in the direction of the shank portion in the interior of the main body.

In the implanted state, the abutment is connected to a prosthesis, the artificial crown or the dental prosthesis at its upper, coronal part and sits with its lower, apical part on the coronal end of the main body.

In one embodiment, the abutment itself comprises the connecting element (hereinafter referred to as the internal connecting element), i.e., the abutment is extended in the apical region such that it extends into the recess in the main body where the abutment is additionally anchored.

In an embodiment, the connecting element is not fastened to the abutment. The abutment has an opening which extends through the abutment from its upper, coronal part to its lower, apical part. An external connecting element, which fastens the abutment to the main body, is introduced through this opening. The external connecting element is inserted through the opening in the abutment into the recess in the main body.

The lower, apical part, the coupling region of the abutment and the coronal end of the main body, the coupling region of the main body, have a matching positive-locking interface. The coupling region of the abutment has a geometric shape that is opposite to the geometric shape of the coupling region of the coupling portion. In certain regions of the interface, the geometry in the coupling region of the abutment is designed to be congruent with the geometry in the coupling region of the main body. The coupling region of the abutment is intended to be received by the coupling region of the main body. In the mounted state, the coupling region of the lower part of the abutment is connected to the coupling region of the coupling portion of the main body and forms a contact line.

In one embodiment of the solution, the dental implant is a tissue level implant so that the outer surface of the main body is only partially implanted in the alveolar bone and the coupling region of the implant projects at least partially beyond the bone level. In a further embodiment, the implant is provided as a bone level implant that is completely embedded into the bone, which is why the outer surface of the main body is implanted completely in the alveolar bone.

In one embodiment, the main body is 5-30 mm long in the direction of the longitudinal axis, wherein the length is the maximum extent in the direction of the longitudinal axis. The main body is preferably 7-25 mm, particularly preferably 10-20 mm long. So-called short main bodies are 5-10 mm long and long main bodies are longer than 25 mm.

The nominal diameter of the main body is defined as the maximum average of the coupling portion of the main body. Said nominal diameter is preferably located at the level of the bone/the gingiva. The nominal diameter of the main body is particularly preferably located directly below the coupling region. The nominal diameter is preferably in a range of up to 8 mm, preferably up to 6 mm, and particularly preferably up to 5 mm. The nominal diameter is furthermore preferably greater than 1 mm, particularly preferably greater than 2 mm. Depending on the shape-cylindrical, elliptical, etc., of the coupling portion, the diameter can be constant or vary over the circumference of the coupling portion. The central point of the nominal diameter is preferably located on the longitudinal axis. The outer shape of the main body preferably combines portions that are conical, cylindrical and/or provided with threads. Preferably, the coronal end of the main body is conical or cylindrical. Further preferably, the apical end of the main body is conical and preferably has at least one threaded portion and/or an at least partially porous outer surface.

In one embodiment, the abutment is 3-10 mm, preferably 5-9, particularly preferably 4-8 mm long in the direction of the longitudinal axis.

In order to enable an anatomical restoration of the teeth, the abutment can have a shape that differs from a cylindrical longitudinal shape. The abutment may have a region that is at an angle to its longitudinal axis.

The diameter of the abutment preferably varies along the longitudinal axis of the implant. The maximum diameter of the abutment is preferably in a range of up to 8 mm, particularly preferably up to 6 mm, and in particular preferably up to 5 mm. In an embodiment, the maximum diameter of the abutment is greater than 1 mm, in a particularly embodiment greater than 2 mm. The outer shape of the abutment is preferably conical or cylindrical or at least partially conical or cylindrical.

In an embodiment, the maximum diameter of the abutment is located directly above the coupling region of the abutment at the apical end of the abutment.

The diameter of the apical part of the abutment may correspond to the diameter of the coronal part of the main body, but it may also be larger or smaller. In one embodiment, the diameter of the apical part of the abutment corresponds to the diameter of the coronal part of the main body or is slightly larger or smaller, wherein the difference between the two diameters is ≤10%, preferably ≤5%, more preferably ≤1%, so that the main body and the abutment have the smoothest possible transition of the outer surface in the region of the interface without abrupt diameter changes in the assembled state. The maximum diameter of the apical region of the abutment, the with the geometry to be connected to the main body, preferably has the same outer shape, e.g., cylindrical, as the coupling portion of the main body to ensure a smooth outer surface of the entire implant that is as continuous as possible. Depending on the shape of the coupling portion of the main body, the diameter of the abutment may also be constant or vary around its circumference in order to produce an interface matching the coupling region of the main body.

Possible sizes and shapes of the outer shape of the main body and the abutment are known from the prior art (e.g., cylindrical with a circular or elliptical base surface, conical). Two-dimensional geometric basic shapes that do not have corners, such as circles and ellipses, are preferred.

The shank portion of the main body extends in along the longitudinal axis of the main body. Said shank portion preferably gets wider from the apical to the coronal part along the longitudinal axis. The diameter at the apical end is preferably smaller than the diameter at the coronal end. In an embodiment, the shape of the coupling portion is cylindrical, cylindrically elliptical or conical, wherein segments of different geometries can alternate along the longitudinal axis. The shank portion may consist of a dense ceramic and have a wound (thread), porous, foamed or rough surface on the outer surface. The outer surface preferably has a roughness Ra of 0.2 to 1.6 μm, preferably 0.5 to 0.8 μm, to ensure good adhesion of the bone cells and the gingival tissue. The roughness of the outer surface can be achieved by sandblasting or etching the body part of the main body. The outer surface may also have at least one thread and/or pores. The thread preferably projects from 0.2 to 1 mm, more preferably from 0.5 to 0.8 mm, from the surface of the shank portion. If the shank portion has a porous outer surface, the pores have a mean diameter of 0.2 to 1 mm, preferably 0.5 to 0.8 mm. A porous outer surface of the body part may additionally be provided with a thread, and an outer surface of the body part provided with a thread may have one or more porous portions. Pores and thread turns lead to improved hold of the shank portion in the bone, since cells can grow around and into these structures.

In one embodiment, the shank portion is provided with an external thread that extends from the apical end toward the coronal end and covers at least parts of the outer surface of the main body.

The porous outer surface preferably consists of a ceramic foam.

The coupling portion of the main body also extends along the longitudinal axis of the main body and forms the coronal end of the main body. The coupling portion may comprise a cylindrical shape with a circular or elliptical base, and have conical segments. The coupling portion of the main body is preferably cylindrical or conical, the coupling portion particularly preferably being cylindrical with a circular base. The coupling portion may consist of a dense (>95%, preferably >99% of the theoretical density) ceramic, and may have a porous, foamed or rough surface on the outer surface. The outer surface preferably has a roughness Ra of 0.2 to 1.6 μm, more preferably 0.5 to 0.8 μm, to ensure good adhesion of the bone cells and of the gingival tissue. The roughness of the outer surface can be achieved by sandblasting or etching the coupling portion. As described for the shank portion, the outer surface of the coupling portion may have threads and/or pores.

The abutment also extends along the longitudinal axis. The shape of the abutment may be conical or cylindrical with a circular or elliptical base. Segments of different geometry may alternate. The abutment may consist of a dense ceramic and have a porous, foamed or rough surface on the outer surface. The coronal end of the abutment has features known from the prior art to ensure connection with the dental prosthesis, the crown.

Both the main body and the abutment may be formed from titanium, titanium alloy, polymers or ceramic. Preferred polymers are PE, PEK, PEKK, PEEK or CFK PEEK, particularly preferably fiber-reinforced polymers from the aforementioned list. The main body and/or the abutment is/are preferably produced from ceramic, particularly preferably from zirconium dioxide or zirconium dioxide alloys, such as yttrium oxide-stabilized zirconium dioxide (Y-TZP) or aluminum oxide-prestressed zirconium dioxide (ATZ) or cerium oxide-stabilized zirconium dioxide. In an embodiment, the main body and the abutment are made of the same material.

In the implanted state, the abutment and the main body are positioned one above the other, wherein the lower end, the apical end of the abutment and the coronal end of the main body, form the matching interface, and are in contact with one another. The implant is fastened with a connecting element. The main body has a recess into which the connecting element is inserted. The recess, a bore, a cavity, extends through the coupling portion from the coronal end of the main body in the direction of the shank portion of the main body. The recess preferably extends into the shank portion of the main body. In an embodiment, the recess is a central recess located in the center of the main body and extending along the longitudinal axis from the coronal end in the direction of the apical end. The recess preferably has a cylindrical part at the coronal end of the main body. Further preferably, the cylindrical shank is part of the longitudinal axis of the main body. The cylinder is preferably a rectangular cylinder having a circular base surface, but may also have an elliptical or otherwise non-circular base. The recess extends partially into the shank portion. The shank portion is closed at the apical end of the main body. In an embodiment, the recess extends over a maximum of ¾ of the total length of the main body in the direction of the shank portion of the main body. ¼ of the length of the main body at the apical end is designed to be solid, i.e., the recess ends before this portion of the main body. The recess, the bore, may further comprise a threaded portion in the interior, which is preferably arranged in the apical end of the recess. An inner connecting recess, which has a portion with an internal thread, is intended for receiving a connecting element which is used to secure the abutment mounted on the main body.

The minimum wall thickness around the recess in the interior of the main body is preferably ≥0.65 mm, a wall thickness of ≥0.8 mm is more preferred, a wall thickness of ≥1 mm being particularly preferred.

The coupling portion is located at the coronal end, the upper region of the main body. The coupling portion of the main body comprises a coupling region which is located between the outer surface of the main body and the recess. The coupling region comprises the region between the edge from the outer surface of the main body, the outer transition region, up to the edge into the opening into the interior of the main body, the inner transition region, and encloses the recess. The edge which extends into the recess and/or the edge which extends in to the outer surface of the main body is preferably rounded to prevent wear and damage to the coupling region. This surface of the coupling region is preferably precision machined with tolerances of less than 0.05 mm and may be fired, ground or polished.

The coupling region is concavely or convexly curved. The radii with which the edges are rounded and the radius of the coupling region which is concave or convex may be the same or different, depending on the design. Preferably, the radii of the inner and the outer transition region and of the central part are constant around the recess in the profile of the coupling region and do not have any interruptions. As a result, the same radius is present at every point of the coupling region.

In an embodiment, the coupling region of the main body is designed to be concave and the radii of the transition regions merge tangentially into the coupling region. A concave surface with radii continuously merging into one another is created.

In one embodiment, the rounded transition regions extend such that they meet the inner and outer surfaces, i.e., a completely rounded coupling region without edges or step-like transitions is created.

The convexly designed coupling region of the coupling portion of the main body is referred to as a male part. The apical end of the abutment, the concave coupling region of which is provided with a matching female part. The two parts form the matching interface.

The male coupling region at the coronal end of the main body is intended to be received by the female coupling region at the apical end of the abutment.

The concave coupling region, part of the interface, is located in the lower region of the abutment, the end that meets the main body in the mounted state. The coupling region of the abutment is located between the outer transition region, the outer surface of the abutment up to the inner transition region, the opening for an external connecting element. If the abutment has an integrated connecting element, the inner transition region is located between the coupling region and the integrated connecting element.

The inner and outer transition regions are also preferably rounded on the abutment to prevent wear and damage to the abutment. The coupling region of the abutment extends from between the inner and outer transition regions. This region may be concave or alternatively convex, opposite to the shape of the coupling region of the main body. A convex coupling region of the main body matches a concave coupling region of the abutment, and vice versa. The radii with which the transition regions are rounded and the radius of the coupling region which is shaped concavely or convexly may be the same or different. The radii of the inner and the outer transition region and of the coupling region are preferably constant in the profile of the coupling region around the opening or the connecting element and have no interruptions.

The geometric shape of the coupling region of the abutment is adapted to the geometric shape of the coupling region of the main body and follows its design. If the geometric shape of the coupling region of the main body is uniform across the circumference of the main body, the geometric shape of the coupling region of the abutment is likewise formed uniformly across the circumference of the abutment.

The convex coupling region of the abutment and the concave coupling region of the main body form the interface. The coupling regions of the main body and the abutment, which are designed to be convex or concave, touch one another and form a contact line. The contact line is created because the two coupling regions that meet are curved, with the convex coupling region having a greater degree of curvature than the concave coupling region. The two coupling regions are designed so that a contact line is created after the main body and the abutment have been joined together. The interface according to the solution results in a contact line after assembly. Individual contact points at which load peaks may arise are thereby avoided.

In the plan view along the longitudinal axis, the contact line appears circular, elliptical, hyperbolic, or it corresponds to an edge-free free-form, an irregular ellipse, an irregular circle. Preferably, the contact line is circular or at least approximately circular (within manufacturing tolerances) or regularly elliptical. Preferably, both coupling regions, when they are in contact with one another, form a closed contact line, i.e., the main body and the abutment meet within the coupling regions and form a closed contact line which, with the exception of manufacturing tolerances, has no intended interruptions, for example due to recesses or notches within a coupling region. The manufacturing tolerances can lead to very small deviations and discrepancies within the closed contact line. In an embodiment, the contact line is circular or at least approximately circular (within manufacturing tolerances). This facilitates production and insertion of the implant. Furthermore, a circular contact line also results in the self-centering of the abutment relative to the main body.

In the embodiment, the diameter of the contact line is 99%-40% of the nominal diameter of the main body when viewed from above, i.e., when the contact line is projected into a plane. The nominal diameter of the main body is the maximum diameter of the coupling portion of the main body. The diameter of the contact line is preferably 95%-65%, preferably 90%-80% of the nominal diameter of the main body.

In one embodiment, the concave and/or convex shaped coupling regions of the abutment and main body are free-form curves which do not run in parallel with one another. The concave coupling region is somewhat less curved than the convex coupling region. This ensures that the convex coupling region fits into the space formed by the concave coupling region. In the assembled state of abutment and main body, the coupling regions described above are arranged at a distance from one another at their ends, at the inner and outer transition regions. Starting from the inner and outer transition region, the distance is reduced in the direction toward the center of the coupling regions, where these are in contact in the assembled state. The contact line is created. In another embodiment, the concave and convex coupling regions are hyperbolic or diametrical parts of an ellipse.

In one embodiment, the difference of the bend, the curvature of the concave and convex region, respectively, over the distance from the inner transition region to the outer transition region of the two bent or curved coupling regions, is at least 2 times the manufacturing tolerance (the manufacturing tolerance is preferably at most 0.05 mm), preferably at least 5 times the manufacturing tolerance, wherein the concave coupling region is less bent or curved than the convex coupling region. A line contact between the coupling regions is thereby ensured. According to the solution, the geometric shapes of the coupling regions of the abutment and of the main body are different. The geometric shapes deviate at least to the extent that a line contact is created in the assembled state. It is immaterial here whether the deviations of the geometric shape of the coupling regions result from the design or due to tolerances during production. If the difference between the bends of the coupling regions is too small, surface contact can occur instead of line contact. The properties, e.g., the force application, of surface contact are different to those of line contact and are disadvantageous for the reliable permanent use of the interface. Line contact is provided for an implant according to the solution made of ceramic materials.

In an embodiment, both the concave and the convex coupling region are a circular segment in cross section. The center of the circle, which corresponds to the circular segment that forms the concave coupling region, is located within the part which comprises the convex coupling region. The center of the circle corresponding to the circular segment that forms the convex coupling region is located within an imaginary extension of the part which comprises the concave coupling region. Both circular segments have a radius. The radius of the circle forming the concave coupling region is 0.1-10%, preferably 1-5% greater than the radius of the circle forming the convex coupling region. In an embodiment, the radius of the convex coupling region is in the range of from 10 to 50% of the nominal diameter of the main body.

In the assembled state, the opposing ends of the coupling regions are arranged at a distance from one another. Said distance is present at the outer and one at the inner transition region of the coupling regions. Said distance and consequently the gap formed thereby is preferably as small as possible. This is achieved by the convex coupling region being bent only slightly more strongly than the concave coupling region. According to the solution, the coupling regions are designed so that, when the abutment and the main body are assembled, a contact line is created, wherein the distance between the coupling regions in the transition region, i.e., in the end regions of the coupling regions, is as low as possible. In one embodiment with circular geometries as the concave and convex coupling regions, this is achieved in that the nominal radii of the convex and concave coupling regions deviate only slightly from one another. The radius of the convex coupling region must be smaller than the radius of the concave coupling region to ensure that the convex coupling region fits into the space formed by the concave coupling region. The ratio of convex radius:concave radius preferably is: concave radius 0.8-0.999:1, more preferably is a ratio of 0.9-0.98:1 and particularly preferably is a ratio of 0.94-0.96:1. In one embodiment, the difference between the two radii is 5 times the manufacturing tolerance (for example, 0.05 mm), preferably 10 times the manufacturing tolerance, wherein the concave radius is greater than the convex radius to ensure the line contact.

The interface according to the solution consisting of a convex and a concave coupling region, according to the specifications described above, is advantageous irrespective of parameters that exist in the production of ceramic products such as shrinkage during sintering, and/or material removal during polishing. The two coupling regions designed according to the solution always form a line contact. In the case of a circular circumference of the central parts of a coupling region, the contact line forms a circle in plan view. Said circle encloses the recess in the main body and the opening or the connecting element of the abutment. This interface according to the solution
protects the coupling regions and thus the abutment and the main body from stresses and loads,
ensures self-centering of the two touching parts.

In one embodiment, the interface according to the solution is arranged symmetrically around the longitudinal axis of the dental implant assembly. The contact line, formed by the convex coupling region and concave coupling region, is located in one plane. Said plane may be perpendicular or at an angle to the longitudinal axis.

In another embodiment, in at least one region the contact line between the abutment and the main body of the interface according to the solution is arranged at a spacing from a plane aligned perpendicularly to the longitudinal axis of the dental implant assembly. This means that the contact line has at least one valley, a depression, and at least one peak, an elevation, relative to said plane. A depression in the coupling region of the main body is located opposite an elevation in the coupling region of the abutment. The deepest point of a depression in the coupling region of the main body represents the point of maximum distance of the convex or concave coupling region which intersects a plane perpendicularly to the longitudinal axis which is further in the direction of the apical end of the main body than the planes which intersect the next points on both sides of the profile of the coupling regions. The highest point of an elevation is the counter-part of a depression and represents the point of maximum distance of the convex or concave coupling region which intersects a plane perpendicularly to the longitudinal axis which is further in the direction of the coronal end of the main body than the planes which intersect the next points on both sides of the profile of the coupling regions. The same applies, mutatis mutandis, to an elevation or depression in the coupling region of the abutment. The deepest or highest point of a depression or elevation, respectively, thus represents an apex.

In one embodiment comprising an elevation and a depression, the contact line is arranged at an angle to the longitudinal axis. Due to the angularly arranged contact line in conjunction with the shear forces that may thereby result, it is necessary for a stable connection between the abutment and the main body that the connecting element, preferably the screw, has a length of at least 1.5 times its diameter.

In an embodiment, the profile of the coupling region has more than one depression and one elevation, preferably 2, 3 or 4 depressions and elevations. Further preferred is an even number of depressions and elevations. In an embodiment, the distances between the depressions and elevations of the coupling region are symmetrical, i.e., the distance between each depression and the subsequent elevation (and vice versa) is the same. In one embodiment, the coupling region of the main body has a first elevation, a second elevation and a first depression between the first elevation and the second elevation, and a second depression between the second elevation and the first elevation, and the elevations and depressions are preferably diametrically opposite one another. The same applies, mutatis mutandis, to the abutment with the requirement that the geometry matches the main body.

In an embodiment, the coupling region has two depressions and two elevations and is preferably symmetrical, i.e., the depressions and the elevations are arranged opposite one another in the coupling region. A coupling region designed in this way functions both as an anti-rotation means and as a self-securing element. In the course of assembly, as soon as the depressions and elevations of the main body and the abutment are aligned, a connecting element is introduced through the opening in the abutment and into the recess in the main body and fastened in the interior of the main body. After the connecting element has been fastened, rotation of the abutment on the main body is ruled out, since, for a rotational movement, the coupling region requires a vertical displacement of the abutment, i.e., the abutment must move upwards to compensate for the depressions and elevations and to enable a rotation. This vertical displacement is prevented by a by the connecting element. In addition, during assembly, the abutment on the main body is moved radially on the main body until the elevations and depressions interlock, i.e., an elevation in one coupling region “latches” into a depression in the other coupling region. In the prior art, the connecting element does not only serve to fasten, but also to prevent rotation, and therefore often has a non-circular outer shape. In an assembly according to the solution of the above-described embodiments with elevations and depressions, rotation prevention is ensured solely by the shape of the coupling region. The connecting element only has the task of securing the abutment and the main body. The connecting element does not have to comprise additional rotation prevention. The connecting element, preferably a screw, can therefore have a circular cross section of the outer shape, i.e., a conical or cylindrical screw body, preferably having a thread. This design makes it possible for the connecting element to be designed in a robust shape with a maximum diameter. By using a connecting element having a maximum diameter, greater prestress and thus higher flexural strength and stability can be achieved.

A connecting element with rotation protection has a circumferential reduction at at least one location. As a result, the cross section is reduced compared to a circular cross section, which on the whole leads to a reduction in stability of the connecting element.

In a further embodiment, the depressions and elevations follow the natural gum line so that the appearance in the implanted state is aesthetically pleasing. In an embodiment, the artificial tooth or the crown can then simply be fastened to the abutment and does not have to cover the main body. If the main body is placed in the jawbone, the gum line is not changed or modified thereby, and a natural appearance is maintained. In such an embodiment, the at least two depressions are not arranged on one plane arranged perpendicularly to the longitudinal axis. The planes on which the depressions lie are arranged at a distance from one another. One plane is arranged further in the direction of the apical end than the other plane. If 2 elevations and 2 depressions are present, the apex of the first depression of the coupling region of the main body is more coronal than the apex of the second depression. In another embodiment, the apex of the first elevation is more apical than the apex of the second elevation. The apexes can be arranged according to requirements. All apexes may be arranged at a distance from the longitudinal axis of the dental implant assembly. All apexes then lie on planes that are spaced apart perpendicularly to the longitudinal axis. The same applies, mutatis mutandis, to the elevations and to the profile of the coupling region of the abutment. Coupling regions of the main body and abutment according to the solution are formed so as to interlock with one another and lock into one another in the implanted state. Therefore, in the mounted state, a continuous contact line forms between the abutment and the main body. If the deepest apex is located on the buccal side in the implanted state, an aesthetically pleasing facial front can be ensured. If the oral side is also adapted to the natural gum line, a dental implant assembly according to the solution naturally mirrors reality. This means the smallest possible, ideally no, irritation for the patient.

The difference between the individual depressions and elevations is preferably 0.1-2 mm, more preferably 0.3-1 mm and particularly preferably 0.3-0.5 mm. In one embodiment, the ratio between the distance between adjacent apexes, i.e., between a depression and an elevation located in the direct vicinity, and the diameter of the contact line is 0.025 to 0.5:1.

Preferably, the profile between the apexes is smooth and curved, i.e., without sharp edges and steps.

The abutment is fastened to the main body by a connecting element. The connecting element may be an internal connecting element already fastened to the abutment, which connecting element is enclosed by the coupling region and projects therebeyond such that it can be introduced into the recess in the main body and fastened there. An internal connecting element is preferably fastened in the recess by additional adhesive agents, dental fastening means such as adhesives or cement.

In an embodiment, the connecting element is not fastened to the abutment. It is an external connecting element. The abutment has an opening for the passage of a connecting element, which opening extends through the abutment from the apical to the coronal part. Preferably, the external connecting element is a screw which is screwed into a threaded portion of the recess in the main body. The opening in the abutment contains retaining means which are matched to the connecting element to ensure a tight fit and secure fastening of the abutment. One or more projections, which project from the wall of the abutment and into the opening, are preferably located within the opening. In the mounted state, said at least one projection is in contact with one region of the external connecting element, e.g., the screw head. The projection is preferably angled to ensure a maximum contact surface between the region of the connecting element and the abutment. In an embodiment, the projection is conical. The projection extends from the coronal part of the abutment to the apical part of the abutment and reduces the diameter of the opening toward the apical part.

In an embodiment, the head of the external connecting element and the corresponding retaining elements, preferably the projections, of the abutment form a circular contact line near the shank of the connecting element. This makes it possible to increase the torque during insertion that must be used to fasten the fastening element. Such a contact line can be achieved by conical projections in the opening in the abutment and a convex radius of the head of the external connecting element, preferably of the screw head. The above-described geometric shape, the conical projection, may alternatively be provided on the connecting element. The convex radius is then arranged at the projection of the abutment. Irrespective of the arrangement of the above-described geometric shapes, a circular contact line between the connecting element and the abutment for securing the dental implant assembly is advantageous.

The connecting element may be selected from the prior art. The connecting element may be, for example, a screw, a bayonet lock, a bolt or a securing pin. A screw for fixing the abutment to the main body is preferred.

The external connecting element is preferably a screw. The screw is shaped such that it fits into the opening in the abutment and fastens the abutment to the main body. Preferably, the head of the screw is conically or convexly shaped so that it can be fitted into the opening and is non-positively connected to the opening and/or retaining elements that may be present in the interior of the opening. Further preferably, the screw has a thread for interacting with a thread present in the interior of the recess in the main body.

The external connecting element, preferably the screw, is made of metal, metal alloys, ceramic or plastics. Preferably, the external connecting element or the screw consists of polymers such as PE, PEK, PEKK, PEEK or CFK PEEK, even more preferably these polymers are fiber-reinforced polymers. In an embodiment, the main body and the abutment consist of ceramic and the external connecting element, preferably the screw, consists of plastics, preferably of polymers from the aforementioned list.

Preferably, the maximum extension of the screw along the longitudinal axis of the main body is at least 1.5 times, preferably at least 2 times as long as the maximum diameter of the screw.

In one embodiment, fastening of the screw can be further improved by using an adhesive agent which is applied to the screw, the abutment and/or the main body. The adhesive agent is preferably a dental fastening means, a dental adhesive or dental cement.

In an embodiment, the abutment is anchored only using the external connecting element, i.e., purely mechanically without the use of adhesive agents such as adhesives or cement.

According to a further aspect of the present solution, a dental kit is provided which comprises the following:
a dental implant assembly as described above, and
a dental prosthesis, an artificial crown.

The dental kit is intended for complete replacement of a tooth. In the mounted state, the dental prosthesis is in contact with the abutment. If necessary, the dental prosthesis can also be in contact with the main body, in particular if it is a tissue level implant. The dental prosthesis covers at least parts of the dental implant assembly. Preferably, the dental prosthesis covers the part of the dental implant assembly which protrudes from the gums. Depending on the type of implant, tissue level or bone level, either only the abutment (tissue level) or the abutment and the main body (bone level) are covered.

The dental implant assembly according to the solution can be produced using manufacturing methods known in the prior art (for example with a conventional CNC milling machine or by means of CIM or other molding methods). Since the connecting element has a reduced cross section compared to the dental implants known from the prior art, dental implant assemblies having a main body diameter below 3.5 mm can be realized, while the stability and resistance to force trauma continue to be ensured. The dental implant assembly according to the solution can thus also be used to replace incisors.

The present solution proposes an optimized matching interface geometry which enables load transmission that is as ceramic-friendly as possible in that
the pressure of the two parts on each other is spaced apart from the edges of the inner and outer transition regions, since the contact line is located in the coupling regions,
point loads are minimized due to the concave and convex coupling regions, and load transfer is ensured along a contact line, thereby enabling a ceramic-on-ceramic implant, and
the edges of the transition regions are rounded, thereby avoiding cutting injuries, increasing stability and reducing wear.

Furthermore, with the dental implant assembly according to the solution, rotation prevention is integrated in the contact zone (coupling portion) of the main body and the abutment, whereby more stable connecting elements with a larger diameter, such as screws, can be realized and the stability of the dental implant assembly is thereby increased.

The present solution is also advantageous because
the matching coupling regions of the interface lead to the self-centering of the abutment on the main body when it is fastened to the connecting element,
the coupling regions with a depression-elevation profile result in a self-locking mechanism of the abutment on the main body,
the geometric shape of the coupling regions with two different elevations and depressions allows for an aesthetically pleasing appearance, and
the rounded transition regions of the main body and the abutment protects the gingival tissue, whereby inflammation and irritation in the patient are avoided.

In summary, the present solution describes a dental implant assembly 1 for use in the jawbone of a patient. The dental implant assembly 1 according to the solution serves to receive a dental prosthesis and comprises a main body 3, which connects the dental implant to the alveolar bone (i.e., the jawbone), an abutment 2 and a connecting element 51. The main body 3 and the abutment 2 each have a coupling region 14, 24. Together, these coupling regions 14, 24 form an interface. One of the coupling regions 14, 24 is concave and the other convex and portions of the coupling regions are congruent. The abutment 2 and main body 3 are connected by means of a connecting element 51.

### LIST OF REFERENCE SIGNS

| | |
|---|---|
| 1 | Implant assembly |
| 2 | Abutment |
| 3 | Main body |
| 5 | Diameter of 41 |
| 6 | Depression of 41 |
| 7 | Elevation of 41 |
| 9 | Plane |
| 10 | Interface |
| 11 | Distance |
| 14 | Coupling region |
| 15 | Gap |
| 16 | Internal thread |
| 23 | Opening |
| 24 | Coupling region |
| 26 | Projection |
| 27 | Apical end of 2 |
| 28 | Portion |
| 29 | Coronal end |
| 32 | Apical end of 3 |
| 33 | Shank portion |
| 35 | Coupling portion |
| 36 | Coronal end |
| 37 | Recess |
| 38 | Retaining means |
| 41 | Contact line |
| 51 | Connecting element |
| 241 | Inner transition region |
| 242 | Outer transition region |
| 313 | Diameter of 3 |
| 341 | Inner transition region |
| 342 | Outer transition region |
| I-I′ | Longitudinal axis |
| II-II′ | Axis |
| r3 | Radius of 14 |
| r2 | Radius of 24 |

### BRIEF DESCRIPTION OF THE DRAWINGS

The terms Fig., Figs., Figure, and Figures are used interchangeably in the specification to refer to the corresponding figures in the drawings.

The solution will be explained below with reference to drawings. All drawings contain schematic cutouts of the solution and are used by way of example to explain the solution. Specific embodiments of the solution may differ from these drawings. The dental implant assembly according to the solution in the drawings is illustrated by way of a sketch and in a schematic manner.

In the drawings:

FIG. 1 is a section through a dental implant assembly according to the solution.

FIG. 2 is a perspective view of the dental implant assembly according to FIG. 1.

FIG. 3 is a cross section along the line I-I′ of the dental implant assembly according to FIG. 2.

FIG. 4 is a detail of the contact region between the main body and the abutment.

FIG. 5 is a perspective view of a dental implant assembly with an asymmetrical shape in the region of the interface.

FIG. 6 is a perspective view of the main body of a dental implant assembly according to the solution, having an elevation and a depression in the region of the interface.

FIG. 7 is a cross section of the main body according to FIG. 6.

FIG. 8 is a perspective view of the main body of a dental implant assembly according to the solution, having two elevations and two depressions in the region of the interface.

FIG. 9 is a cross section of the main body according to FIG. 8.

FIG. 10 is a perspective view of the main body of a dental implant assembly according to the solution, having three elevations and three depressions in the region of the interface.

FIG. 11 is a cross section of the main body according to FIG. 10.

FIG. 12 shows a photograph of the interface between the main body and the abutment.

### DESCRIPTION OF THE INVENTION

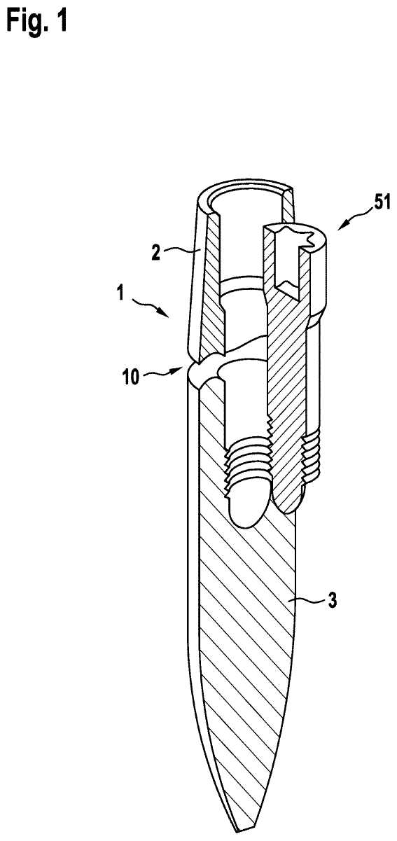

FIG. 1 shows a section through an implant assembly 1 according to the solution. Said implant assembly comprises a main body 3, an abutment 2 and a connecting element 51. In the assembled state, the abutment 2 is positively connected to the main body 3 by means of an interface 10. According to the solution, this interface 10 has features which enable the abutment 2 to be accurately positioned relative to the main body 3.

The features of the implant assembly 1 are described in detail in the drawings below. In particular, for the features of the interface 10, the features described below on the main body 3 and abutment 2 may also be arranged on the respective other part. In other words, in a particular embodiment, the features of the interface 10 described below, which relate to the main body 3, may be arranged on the abutment 2. It is then necessary that the features of the abutment 2 described below are arranged on the main body 3. Exact positioning can thereby be ensured.

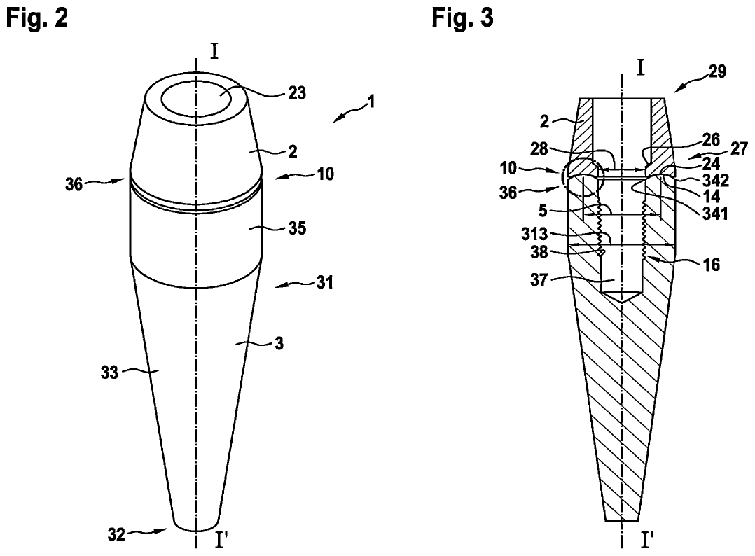

FIG. 2 shows an implant assembly 1 according to the invention having a main body 3 and an abutment 2. The main body 3 has a shank portion 33 at its apical end 32. The shank portion 33 tapers along the longitudinal axis I-I′ in the direction of the apical end 32 and is conical in the embodiment according to FIG. 1. A coupling portion 35 is arranged at the coronal end 36 of the main body 3. The coupling portion 35 is integrally connected to the shank portion 33 of the main body 3 and is part of the interface 10. The interface 10 arranged at the coronal end 36 enables the main body 3 to be positioned so as to interlock with the abutment 2.

As can be seen from FIG. 3, the main body 3 has a recess 37 at the coronal end 36. A connecting element 51 (not shown), with which the main body 3 and the abutment 2 can be releasably connected, is arranged in the recess 37. According to the embodiment according to FIGS. 2 and 3, the coupling portion 35 is symmetrical and has a coupling region 14 at its coronal end 36, at the interface 10. Said coupling region 14 extends from the cylindrical outermost edge of the coupling portion 35 to the recess 37 and has a symmetrical profile. The outer transition region 342 from the coupling portion 35 and the inner transition region 341 from the recess 37 into the coupling region 14 are preferably rounded. The coupling region 14 of the main body 3 is formed by a convex shape and has a radius r3. The coupling region 14 is part of the interface 10.

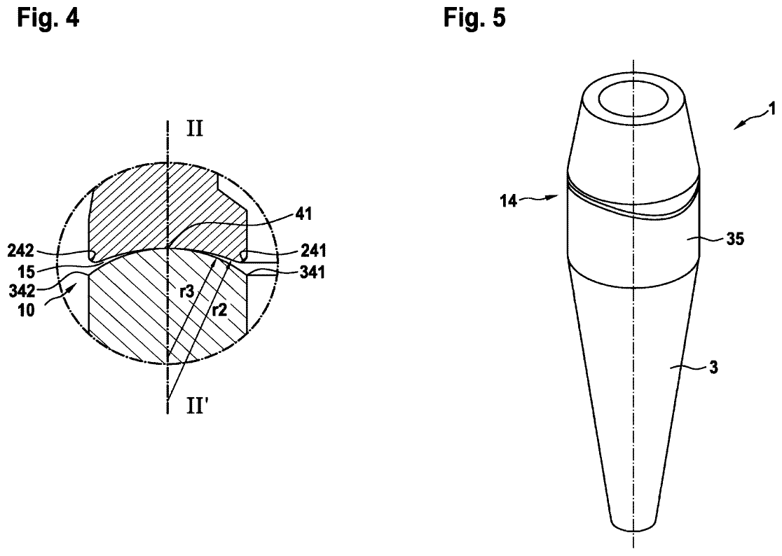

The abutment 2 is designed in the form of a sleeve. It has a through-opening 23 in the form of a bore. A coupling region 24, which is part of the interface 10, is arranged at the apical end 27 of the abutment 2. Said coupling region 24 extends from the cylindrical outermost edge of the abutment 2 to the through-opening 23 and has a symmetrical profile. The outer transition region 242 from the abutment 2 and the inner transition region 241 from the through-opening 23 into the coupling region 24 are preferably designed to be rounded. The coupling region 24 has a concave shape and has a radius r2 (FIG. 4).

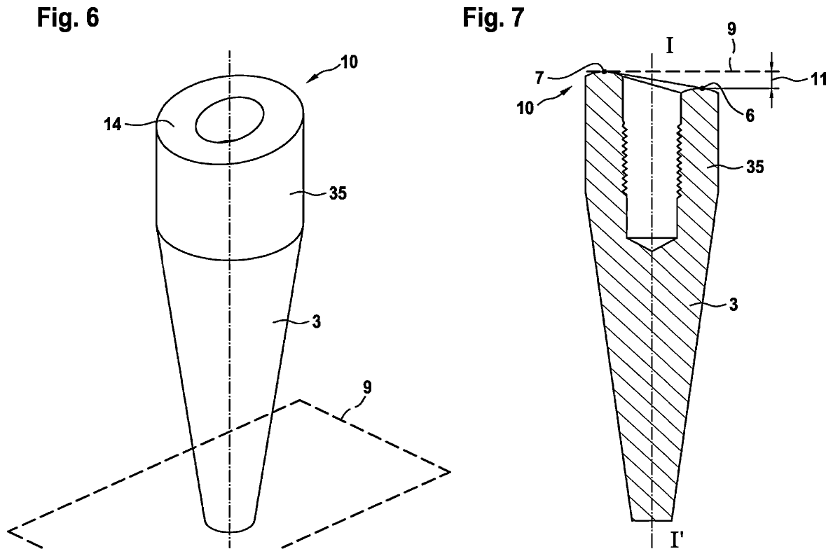

According to the solution, the radii r2 and r3 differ in terms of their values. The radius of the concave coupling region 24 is greater than the radius of the convex coupling region 14. This results in a circular contact line 41 after the abutment 2 and the main body 3 are joined together. Said contact line 41 is arranged in the region of the interface 10 and is formed by a plurality of points strung together. The contact line 41 has a diameter 5 which is smaller than the diameter 313 of the coupling portion 35 (FIG. 3). The center of each of the diameters 5, 313 lies on the axis I-I′. According to the embodiment according to FIGS. 2 and 3, in relation to an imaginary plane 9 (FIG. 6) which is perpendicular to the longitudinal axis I-I′, the linear contact 41 has a constant distance from this plane 9. In other words, the contact line 41 is perpendicular to the longitudinal axis I-I′. All points on the contact line 41 have the same distance to the imaginary plane 9.

The contact line 41 can be seen from FIG. 4. The contact line 41 enables the exact positioning of the main body 3 together with the abutment 2. Due to the different values for the radii r2 and r3, a gap is created in the region of the transitions 341 and 241 as well as 342 and 242. As can be seen from FIG. 4, the transition regions 341 and 342 may be designed to be sharp-edged. This also applies to the transition regions 241 and 242. The transitions 341, 241, 342 and 242 are preferably designed to be rounded.

As can be seen from FIG. 4, starting from the contact line, the gap increases continuously in the direction of the transition regions. In the embodiment according to FIG. 4, the value (distance) of the gap 15, which is determined in parallel with the longitudinal axis, at the transition of the concave coupling region 14 to the transition region 241, 242 is at most 0.05 mm, preferably 0.03 mm, particularly preferably 0.01 mm.

FIG. 3 shows a section through the main body 3 and the abutment 2. The shape of the opening 23 can be seen. To join the main body 3 to the abutment 2, a connecting element 51 (FIG. 1), for example a screw, is inserted into the opening 23. The connecting element 51 extends through the abutment 2 into the main body 3 and is fastened in the main body 3 by means of retaining means 38. For this purpose, the main body 3 has retaining means 38, for example in the form of an internal thread 16. In order to ensure a secure connection between the abutment 3 and the main body 3, the abutment 2 comprises at least one projection 26 which projects into the opening 23. In the embodiment according to FIG. 3, the projection 26 extends around the entire circumference of the opening 23. Said projection is designed to be circular and inclined in the direction of the apical end 27 of the abutment 2. The projection 26, which is designed as a phase, merges into a cylindrical portion 28. Said cylindrical portion 28 forms a guide region for the connecting element 51 and has a smaller diameter than the opening 23 at the coronal end 29 of the abutment 2. The projection 26 is operatively connected to a correspondingly designed region of the connecting element 51, as a result of which a secure connection between the main body 3 and the abutment 2 is ensured.

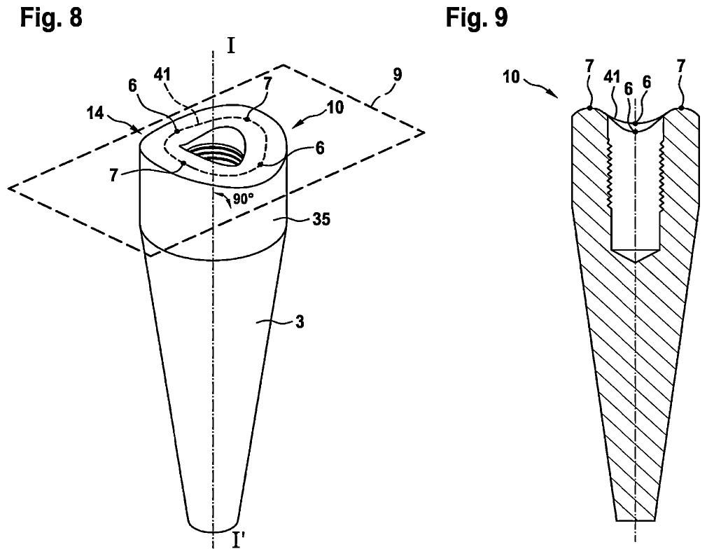

FIG. 5 shows an implant assembly 1 without the connecting element 51. The interface 10 which comprises the coupling portion 35 of the coupling region 14 of the main body 3 is designed to be asymmetrical. This results in the contact line 41 of the coupling region 14 being inclined relative to the plane 9, wherein the plane 9 is oriented perpendicularly to the longitudinal axis I-I′ (FIG. 7). Individual points of the contact line 41 have different distances to the imaginary plane 9. The changes in distance are constant. Under the assumption that the plane 9 is arranged at the coronal end 29 of the coupling portion 35, the contact line 41 has an elevation 7 which intersects the plane 9. Starting from said elevation, the highest point 7 of the contact line 41, this is continuously inclined up to a depression 6 of the lowest point of the contact line 41. At this point 6, the distance 11 from the plane 9 is greatest. Starting from the lowest point 6, the contact line 41 increases continuously up to the highest point 7. The contact line 41 according to FIGS. 5, 6 and 7 has an elevation at point 7 and a depression at point 6.

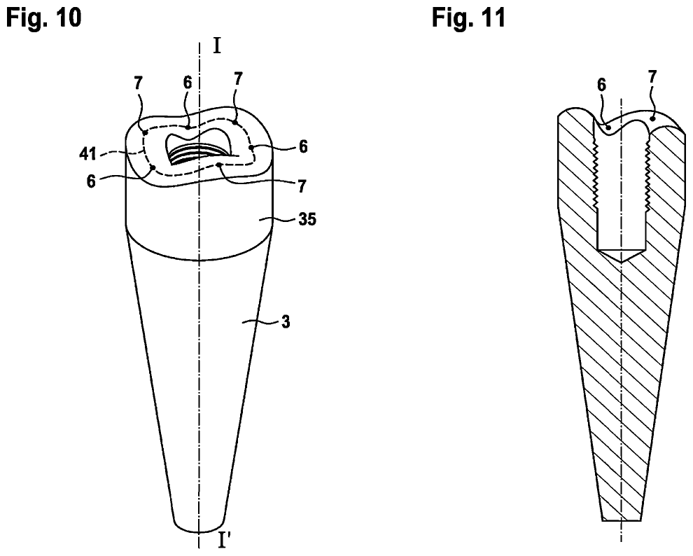

The contact line 41 of the interface 10 according to one embodiment according to FIGS. 8 and 9 have two elevations 7 (highest point) and two depressions 6 (lowest point). Otherwise, the above feature descriptions apply mutatis mutandis.

FIGS. 10 and 11 show the main body 3 of a dental implant assembly 1 according to the solution, the contact line 41 of which has three elevations 7 and three depressions 6. Otherwise, the above feature descriptions apply mutatis mutandis.

The contact line 41 of an interface 10 of a dental implant assembly 1 according to the solution is formed by the interaction between the coronal end 29 of the coupling portion 35 and the apical end 27 of the abutment 2. The above description of the shape of the contact line 41 which uses the main body 3 as an example applies, mutatis mutandis, to the contact line 41 of the abutment 2. The apical end 27 of the abutment 2 and the coronal end 29 of the main body 3 are congruent in portions, with the values for the diameters r2 and r3 differing. The diameter at the convex end is smaller than the diameter at the concave end. This is irrespective of on which part (main body 3, abutment 2) the convex or concave part is arranged. Joining the main body 3 and the abutment 2 together creates the contact line 41.

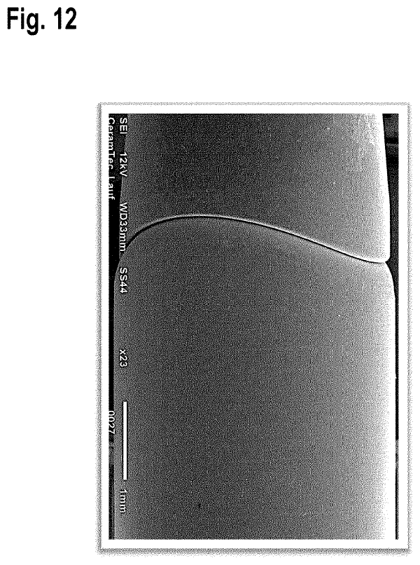

FIG. 12 shows a photograph of an abutment 2 and a main body 3 in the assembled state. The abutment 2 has a maximum length (extension along the longitudinal axis I-I′) of 6 mm and a maximum diameter of 3.9 mm. The lower part of the abutment 2 is cylindrical, the upper part is conical, with the width along the longitudinal axis decreasing toward the upper part. The coupling portion 35 of the main body 3 is cylindrical. The main body 3 is 20 mm long and has a nominal diameter of 4 mm. The abutment 2 is fastened to the main body 3 using a screw (not shown) with an ISO M2 thread. The abutment 2 comprises the concave coupling region 24, the main body 3 the convex coupling region 14. The concave and convex coupling regions are circular segments. The circle of the concave coupling region 24 has a radius of 1.1 mm, that of the convex coupling region 14 has a radius of 1.0 mm. The centers of the radii, the coupling regions 14, 24, lie within the main body 3 and are arranged at a distance of 0.5 mm from the circumference of the coupling portion 35 of the main body 3. The coupling regions, in particular the region in which the contact line 41 is arranged, have been machined in the green state. Additional machining in the form of smoothing or polishing in the fired state is not required. The transition regions 241, 242, 341, 342 are provided with a radius of 0.05 mm. The coupling regions of the dental implant assembly have two elevations 7 and two depressions 6. The elevations 7, likewise the recesses 6, intersect planes which are arranged perpendicularly to the longitudinal axis. The planes are arranged at a distance from one another. The distance between the maximum extents of the elevations 7 and depressions 6 is 0.6 mm.

As can be seen in the photograph, the coupling regions 14, 24 do not have sharp edges and steps. All regions are designed to be curved and rounded so that there are no punctiform loads on tissue and bones. Irritation in the form of inflammation, damage, etc. can thus be virtually eliminated, ideally avoided. In this embodiment, the coupling region 14 of the main body 3 merges tangentially into the cylindrical surface of the coupling portion of the main body 3.

1. A dental implant assembly comprising
a main body which is introduced at least partially into the jawbone, comprising a recess which extends from the coronal end of the main body in the direction of the apical end and a coupling region at the coronal end which encloses the recess and is concavely or convexly curved,
an abutment, wherein the abutment has an apical coupling region which is aligned with the main body and has a convex or concave geometry opposite to the coupling region of the main body,
wherein the coupling region of the main body forms an interface with the coupling region of the abutment, and wherein the curvature of the concave coupling region is smaller than the curvature of the convex coupling region,
and
a connecting element for fastening the abutment to the main body.

2. The dental implant assembly according to claim 1, wherein the main body and/or the abutment is/are made of titanium, titanium alloys, plastics or ceramic.

3. The dental implant assembly according to either claim 1, wherein the main body and/or the abutment is/are made of ceramic, preferably of zirconium dioxide or zirconium dioxide alloys, such as yttrium oxide-stabilized zirconium dioxide or aluminum oxide-reinforced zirconium dioxide or cerium oxide-stabilized zirconium dioxide.

4. The dental implant assembly according to claim 1, wherein the abutment and the main body consist of the same material.

5. The dental implant assembly according to claim 1, wherein the interface has a convex coupling region of the main body and a concave coupling region of the abutment.

6. The dental implant according to claim 1, wherein the coupling regions of concave and convex shape form a contact line, preferably a contact line which is circular or at least nearly circular in plan view.

7. The dental implant assembly according to claim 6, wherein the diameter of the contact line is 40-99% of the diameter of the coupling portion of the main body in plan view.

8. The dental implant assembly according to claim 1, wherein the coupling regions of the abutment and of the main body have at least one elevation and at least one depression, preferably an even number of elevations and depressions.

9. The dental implant assembly according to claim 8, wherein the coupling region of the main body have a first elevation, a second elevation and a first depression-between the first elevation and the second elevation, and a second depression-between the second elevation and the first elevation, and preferably the elevations and depressions are diametrically opposite one another.

10. The dental implant assembly according to claim 9, wherein the most apical point of the first depression of the coupling region of the main body is more coronal than the most apical point of the second depression and/or the most coronal point of the first elevation is more apical than the most coronal point of the second elevation.

11. The dental implant assembly according to claim 1, wherein the connecting element is an external connecting element which is introduced through an opening in the abutment which extends into the recess in the main body from the coronal to the apical end of the abutment.

12. The dental implant assembly according to claim 11, wherein the connecting element is a screw.

13. The dental implant assembly according to either claim 11, wherein the external connecting element is made of a plastics, preferably of PE, PEK, PEKK, PEEK or CFK PEEK, particularly preferably of fiber-reinforced PE, PEK, PEKK, PEEK or CFK PEEK.

14. A dental kit comprising at least one dental implant assembly according to claim 1 and at least one dental prosthesis.
